(19) United States
(12) Patent Application Publication
(10) Pub. No.: US 2022/0410564 A1
(43) Pub. Date: Dec. 29, 2022

(54) PRINTHEAD CALIBRATION

(71) Applicant: Hewlett-Packard Development Company, L.P., Spring, TX (US)

(72) Inventors: Angel Martinez Barambio, Sant Cugat del Valles (ES); Shawn D. Hunter, Corvallis, OR (US); Jordi Falces Valls, Sant Cugat del Valles (ES)

(73) Assignee: Hewlett-Packard Development Company, L.P., Spring, TX (US)

(21) Appl. No.: 17/773,965

(22) PCT Filed: Nov. 13, 2019
(86) PCT No.: PCT/US2019/061114

§ 371 Date: May 3, 2022

(51) Int. Cl. B41J 2/045; G06K 15/02; G06K 15/10

(52) U.S. Cl. CPC B41J 2/04508; G06K 15/027; G06K 15/102; B41J 2/04586

(57) ABSTRACT

According to an example, a calibration method may calculate a printhead distribution. The method may comprise printing a calibration pattern, detecting darkness values from the calibration pattern, assigning a darkness level to a plurality of printheads based on the darkness values, and calculating through a processor the printhead distribution that minimizes a variation of the darkness levels across the plurality of printheads.

### BACKGROUND

Printhead calibration is used in many types of printing systems having different sizes. When printing solid areas in a media, calibration of the printheads enables to detect possible defects which would result from a printing operation. Defects such as banding or nozzle clogging may reduce the quality of a media during a printing operation. To minimize the consequences of the defects in the printing operation, the printhead calibration is crucial, It is hereby disclosed a printhead calibration in which a distribution of a plurality of printheads may be calculated from a printed diagnostic plot.

### BRIEF DESCRIPTION OF DRAWINGS

Features of the present disclosure are illustrated by way of example and are not limited in the following figure(s), in which like numerals indicate like elements, in which;

FIG. 1a shows a first printhead distribution for a plurality of printheads, according to an example of the present disclosure;

FIG. 1b shows a second printhead distribution for the plurality of printheads of FIG. 1a;

FIG. 2a shows a plurality of printheads distributed in a series of printbars in a first distribution, according to an example of the present disclosure;

FIG. 2b shows the plurality of printheads of FIG. 2a in a second distribution;

FIG. 3a shows a plurality of printheads comprising dies, according to an example of the present disclosure;

FIG. 3b shows the plurality of printheads of FIG. 3b in a second printhead distribution;

FIG. 4 shows a calibration method to determine a printhead distribution, according to an example of the present disclosure;

FIG. 5 shows a calibration method for printheads comprising dies, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Disclosed herein are examples of printhead calibration devices, calibration methods, and printing systems which may be used to determine a printhead distribution. Hence, different examples of devices, methods, and systems are described.

When performing a printing operation, a user may notice that the actual results and the expected results diverge. One possible cause for the difference may be the printheads workload. Another possible cause may be the printhead age. Another possible cause may be that some of the printheads performing the printing operation are faulty. These causes along with other ones may be detected if a proper calibration of the printing operation is performed.

One defect that a user may notice when printing in a large format printer is banding. Banding may be described as consistent, straight regions wherein print density differs from neighboring regions. When having a big amount of printheads in a printing operation, banding may contribute to bad quality results that the user does not desire. Banding compensation methods have been designed to reduce the impact of the defect through the modification of the amount of printing fluid flushed by the printheads. However, other alternatives may be possible, such as modifying the printhead distribution.

Large format printers may have a large number of printheads distributed in a series of parallel printbars. For instance, when having 26 printheads in each of the 14 printbars the complexity of the troubleshooting is high. In order to increase the output quality, a user may need to identify the printheads which contribute to bad quality results.

According to an example, a calibration method to calculate a printhead distribution may comprise printing a calibration pattern through a series of nozzles comprised within a plurality of printheads, detecting darkness values from the calibration pattern, assigning a darkness level to the plurality of printheads based on the darkness values, and calculating the printhead distribution. The printhead may eject a target amount of printing fluid through a series of nozzles upon a media so that a calibration pattern is formed. The calibration pattern may be read through an optical sensor, in such a way that darkness values are obtained from it. A processor may assign a darkness level to each printhead based on the darkness values obtained from the calibration pattern. In a certain example, upon a darkness level being assigned to each of the printheads, the processor may calculate a printhead distribution that minimizes a variation of the darkness level across the plurality of printheads.

As used herein, “printing fluid” refers generally to any substance that can be applied upon a substrate by a printer during a printing operation, including but not limited to inks, primers and overcoat materials (such as a varnish), water, and solvents other than water. As used herein an “ink” refers generally to a liquid that is to be applied to a substrate during a printing operation to form an image upon the substrate.

Throughout this description, the term “darkness value” refers generally to a degree of darkness for an area printed through a set of nozzles. In an example, an optical sensor may detect the darkness value in a scale comprised between a minimum darkness value and a maximum darkness value. Throughout this description, the term “darkness level” refers generally to a darkness descriptor based on darkness values. In certain examples, the term “darkness level” may be used to refer to an average degree of darkness for a series of printed areas, wherein the series of printed areas may correspond to areas printed by a printhead, a subset of printheads, a die comprised within a printhead, a portion of a die within a printhead, or a plurality of printheads.

According to another example, the calculation of the printhead distribution may comprise comparing the darkness levels of each of the printheads with a threshold darkness level, wherein the printheads having darkness levels which do not exceed the threshold darkness level are excluded from the printhead distribution. In other examples, the printheads to be excluded may remain in the calculation of the printhead distribution if conditions are satisfied.

As used herein, a “printhead distribution” refers generally to a dissemination or allocation of printheads across a printbar or a series of printbars.

According to other examples, the processor receives printhead data from a server. The printhead data may comprise printing fluid usage data and operating life data for the plurality of printheads. In the case that the printing fluid usage data or the operating life data of the printheads to be excluded are lower than a minimum printing fluid usage data and a minimum life, the printheads are not excluded from the calculation.

However, in other examples, the series of nozzles may be comprised in dies and a die darkness level is assigned to each of the dies based on the darkness values readings for the dies. The calibration method may further comprise calculating a variation value for each printhead and excluding from the calculation of the printhead distribution the printheads for which the variation value is greater than a threshold variation value. The variation value may be calculated as a difference between the die darkness levels of each of the dies comprised within the same printhead.

As used herein, a “printhead die” refers generally to a subsection of a printhead that includes nozzles for ejecting printing fluid, and channels to carry to the printing fluid to nozzles. In examples, a printhead may include a set of dies distributed across a face of the printhead.

In some examples, the printheads may be distributed in a series of printbars. A printbar may comprise a series of printheads positioned adjacent so that the printheads extend along a width. In case of having a series of bars, the printhead distribution calculation of the calibration method may further comprise calculating a printbar distribution for each printbar that minimizes a bar-to-bar variation of the darkness levels of the printheads positioned across the printbars. The bar-to-bar variation may be calculated between the printheads which are positioned at the same width in the series of printbars. According to some examples, the calculation of the printhead distribution across the series of printbars comprises to determine a plurality of printheads changes while minimizing a number of printhead changes.

Throughout this description, the term printhead change will be used to refer to a position variation of a printhead to a different position within the printhead distribution. In case of having more than one printbar, printhead changes may be executed between different printbars.

According to an example, a printing system to read a calibration pattern comprises a plurality of printheads, a processor to calculate a printhead distribution, and an optical sensor. The calibration pattern may be comprised in the media so that the calibration pattern is read through the optical sensor. The plurality of printheads comprise a series of nozzles, wherein the printheads are to print the calibration pattern on the media. The optical sensor may capture darkness values for the series of nozzles from the readings of the calibration pattern, wherein the optical sensor sends a signal to the processor. Upon receiving the signal, the processor may assign a darkness level to each printhead based on the signal. The processor may calculate the printhead distribution that minimizes a variation of the darkness level across the plurality of printheads the printheads. In other examples, instead of a signal the optical sensor may send a set of signals to the processor.

As used herein, an optical sensor refers generally to an apparatus that is to convert light rays into electronic signals. In some examples, the optical sensor measures a physical quantity of light and then translates it into a value that is readable by an instrument.

In an example, the plurality of printheads of the printing system are grouped in a series of printheads subsets and the processor calculates a plurality of printheads distributions that minimize the variation of the darkness level within each subset of printheads.

In other examples, the processor of the printing system excludes from the calculation the printheads which do not fulfill a list of specifications.

In some examples, the processor of the printing system may assign die darkness levels to dies, being the series of nozzles distributed in the dies. In case the printhead does not fulfill a list of specifications, the printhead is excluded from the printhead distribution calculation. In an example, the list of specifications may comprise at least one from the set of a minimum average die darkness level within the printhead, a maximum average die darkness level, and a maximum variation across the dies within the printhead.

In other examples, the calibration pattern is a first calibration pattern and the printheads excluded from the calculation are caused to be replaced for new printheads. Upon the replacement, a second calibration pattern is printed by the series of nozzles and a second printhead distribution is calculated by the processor.

According to an example, a calibration device to calculate a printhead distribution may comprise an optical sensor and a processor to determine the printhead distribution. The optical sensor may capture a plurality of marks from a calibration pattern, wherein the optical sensor obtains darkness values from the marks. The processor assigns a darkness level to a plurality of printheads based on the darkness values of the marks, wherein the processor calculates the printhead distribution that minimizes a difference of the darkness level across the printheads.

According to other examples, the processor comprised in the calibration device excludes from the printhead distribution the printheads having the darkness level lower than a threshold darkness level.

In some examples, the processor of the calibration device receives printhead data from a server, the printhead data comprising printing fluid usage data and operating life data for the plurality of printheads. In case a printhead is determined to be excluded from the calculation of the printhead distribution, if the printing fluid usage data or the operating life data of the printhead are lower than a minimum printing fluid usage and a minimum operating life, the printheads are not excluded from the calculation.

In other examples, the calibration device may comprise a series of parallel printbars in which the plurality of printheads are distributed. When having more than a printbar, the processor may further calculate a series of printbar distributions, wherein the distributions minimize a bar-to-bar variation of each of the darkness levels of the parallel printheads positioned across the printbars.

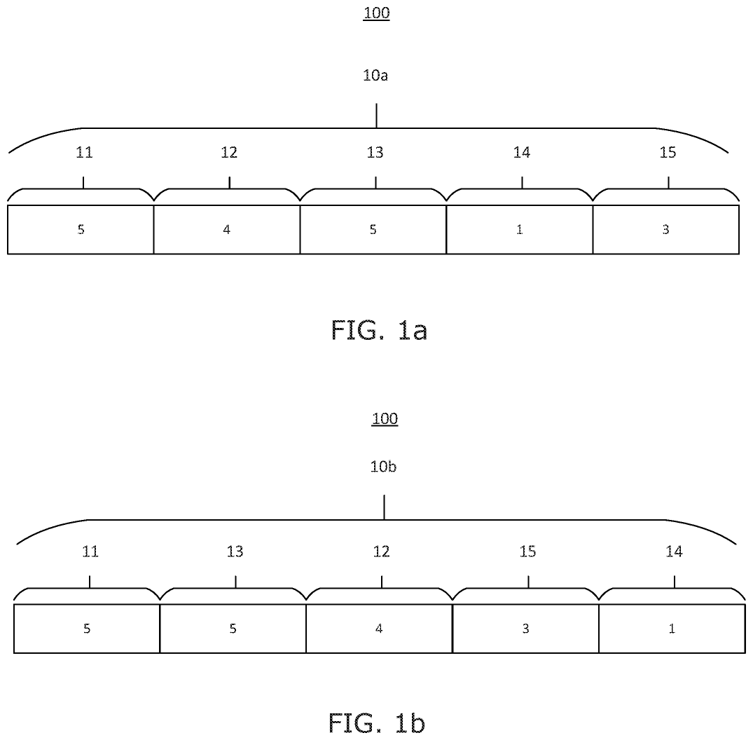

Referring now to FIGS. 1a to 1b, examples of a plurality of printheads 100 are shown in different distributions. In FIG. 1a, the printheads are in a first distribution 10a so that the printheads are distributed adjacent along a width. The plurality of printheads 100 comprises a first printhead 11, a second printhead 12, a third printhead 13, a fourth printhead 14, and a fifth printhead 15. The plurality of printheads 100 may print a calibration pattern (not shown in FIG. 1a) through a series of nozzles comprised within the printheads 11,12, 13, 14 and 15. An optical sensor (not shown in FIG. 1a) may obtain darkness values from the calibration pattern. A processor (not shown in FIG. 1a) may assign darkness levels to each printhead of the plurality of printheads 100 based on the readings of the optical sensor.

In the example of FIG. 1a, the first printhead 11 and the third printhead 13 have a darkness level of 5, the second printhead 12 has a darkness level of 4, the fourth printhead 14 has a darkness level of 1, and the fifth printhead 15 has a darkness level of 3. A variation of the darkness level across the plurality of printheads 100 may be calculated by the processor. The variation of the darkness level between the first printhead 11 and the second printhead 12 is 1, the variation between the second printhead 12 and the third printhead 13 is 1, the variation between the third printhead 13 and the fourth printhead 14 is 4, and the variation between the fourth printhead 14 and the fifth printhead 15 is 2. Then, the variation of the darkness levels across the plurality of printheads 100 is 8.

In FIG. 1b, it is shown an example of the plurality of printheads 100 in a second distribution 10b. The processor may calculate the second printhead distribution 10b based on the darkness levels of the plurality of printheads 100. A criteria to calculate the distribution may be to minimize the difference of the darkness level across the printheads. Whilst the first printhead 11 remains in the position depicted in FIG. 1a, the second printhead 12, the third printhead 13, the fourth printhead 14, and the fifth printhead 15 have changed its positions. The variation of the darkness levels across the printheads in the example of FIG. 1b is 4 (1 between the third printhead 13 and the second printhead 12, 1 between the second printhead 12 and the fifth printhead 15, and 2 between the fifth printhead 15 and the fourth printhead 14). The number of printhead changes performed between the first distribution and the second distribution 10b is 4. In some examples, the processor may calculate a distribution for the printheads that minimizes the variations of the darkness levels across the printheads while minimizing another characteristic, such as a number of printhead changes or a distance between the printhead changes.

In other examples, a printhead may be excluded from the distribution calculation if the darkness level of the printhead does not exceed a threshold darkness level. The printheads excluded from the calculation may be replaced for other printheads.

According to an example, a calibration device may calculate a printhead distribution for a plurality of printheads. The calibration device may comprise an optical sensor and a processor. The optical sensor may capture a plurality of marks from a calibration pattern, obtaining a series of darkness values from the marks. The calibration pattern may be printed by the plurality of printheads so that each of the printheads flushes an amount of printing fluid on a surface. The optical sensor may detect the calibration pattern without analyzing the color so that a darkness value for each of the marks is detected. In an example, the optical sensor detects darkness values from the marks regardless the color of the marks. Upon the optical sensor detecting darkness values, the processor assigns a darkness level to each printhead based on the darkness values of the marks. The processor may determine the printhead distribution that minimizes a difference of the darkness levels across the printheads.

In some examples, when having a plurality of printheads of different colors comprised in a series of printbars, the optical sensor may process the calibration pattern by measuring the darkness values of each of the marks comprised within the calibration pattern. Since the printheads of the same color may be positioned in the same printbar, the processor may determine the printhead distribution that minimizes the variation of the darkness level across the printheads comprised in the printbar. In other examples, when the darkness levels of the printheads are compared with a threshold darkness value, the threshold darkness value may be different depending on the color of the printhead.

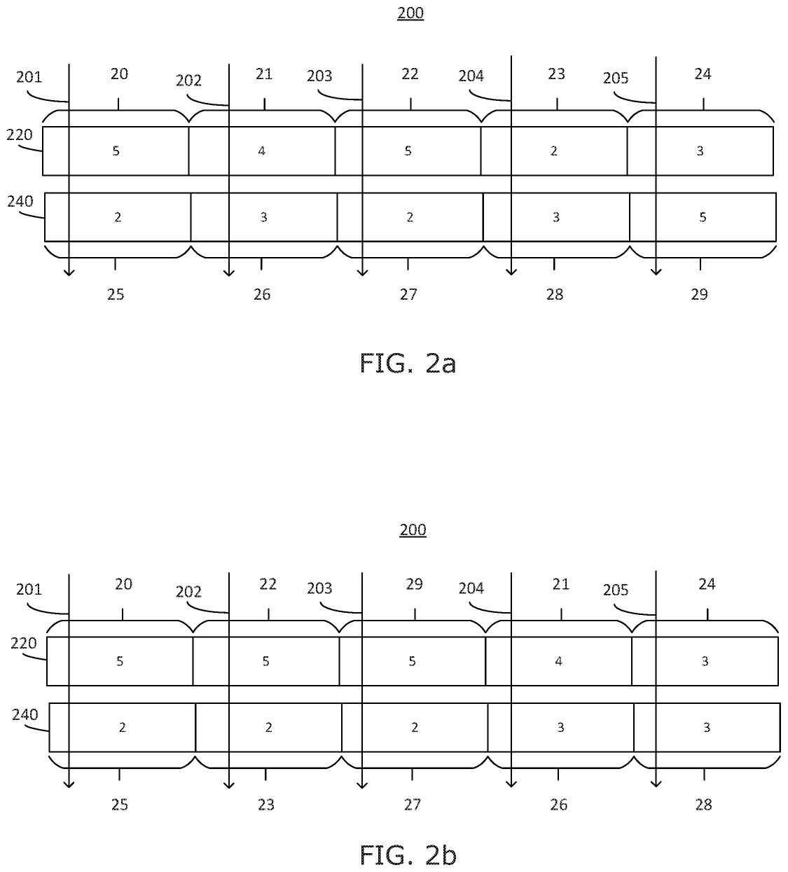

Referring now to FIGS. 2a to 2b, a first distribution for a plurality of printheads 200 comprised in a series of parallel printbars is shown. A first printbar 220 comprises a first printhead 20, a second printhead 21, a third printhead 22, a fourth printhead 23, and a fifth printhead 24. A second printbar 240 comprises a sixth printhead 25, a seventh printhead 26, an eight printhead 27, a ninth printhead 28, and a tenth printhead 29. Each printhead has associated a darkness level, the darkness level being assigned as previously explained in the description. For the first printbar 220, a variation of the darkness level between the printheads is 6. For the second printbar 240, a variation of the darkness level between the printheads is 5.

Additionally, a series of bar-to-bar variations can be calculated for the plurality of printheads 200. The bar-to-bar variation may be calculated as a variation of the darkness level obtained by each column of printheads. A column of printheads comprises all the parallel printheads of the series of printbars. Bar-to-bar levels may be calculated by aggregating the darkness levels of the parallel printheads positioned in the series of printbars. In the example shown in FIG. 2a, the first printhead 20 and the sixth printhead 25 are parallels. In the example depicted, a first bar-to-bar level 201 is 7, a second bar-to-bar level 202 is 7, a third bar-to-bar level 203 is 7, a fourth bar-to-bar level is 5, and a fifth bar-to-bar level is 205 is 8. A bar-to-bar variation between the first bar-to-bar level 201 and the second bar-to-bar level 202 is 0, a bar-to-bar variation between the second bar-to-bar level 202 and the third bar-to-bar level 203 is 0, a bar-to-bar variation between the third bar-to-bar level 203 and the fourth bar-to-bar level 204 is 2, and a bar-to-bar variation between the fourth bar-to-bar level 204 and the fifth bar-to-bar level 205 is 3. Therefore, the bar-to-bar variation for the plurality of printheads 200 is 5.

Referring now to FIG. 2b, a second distribution for the first printbar 220 and the second printbar 240 is shown. A processor (not shown in FIG. 2b) may calculate the second distribution from the first distribution of FIG. 2a. The processor may use as criteria for the distribution calculation to minimize the variation of darkness level between across the printheads of the printbar. In an example, the processor may further include as criteria to minimize the bar-to-bar variation for the plurality of printheads 200. In other examples, the printbar distributions calculation comprises to minimize the bar-to-bar variation while minimizing the number of printhead changes. In some other examples, a user may select a series of criteria weighted for the calculation, wherein the criteria can be one of the explained above.

In the example of FIG. 2b, the plurality of printheads 200 is having a variation of the darkness level for the first printbar of 2 and a variation of the darkness level for the second printbar of 1. In the example of FIG. 2a, the variations of the darkness levels are 6 and 5 for the first printbar and the second printbar, respectively.

Referring now to the bar-to-bar variation, the processor may determine for second distribution of FIG. 2b a value of 1. It should be noted that other alternative printbar distributions may be possible, since the example of FIG. 2b is for illustrative purposes.

According to some examples, a printhead comprises dies, the series of nozzles being comprised within the dies. A die darkness level may be assigned by the processor to each of the dies within a printhead. The processor may assign the die darkness level based on a signal issued by the optical sensor. From the readings of the calibration pattern, the optical sensor may capture darkness values which enable to assign the die darkness level to each of the dies, In some examples, a variation value is calculated for each printhead of the plurality of printheads, wherein the variation value is calculated as a difference between the die darkness levels of each of the dies comprised within each printhead. The variation value may be used to exclude a printhead from the distribution calculation. In an example, a printhead is excluded from the calculation if its variation value is greater than a threshold variation value. In other examples, a printhead to be excluded is not excluded from the calculation because one condition is satisfied.

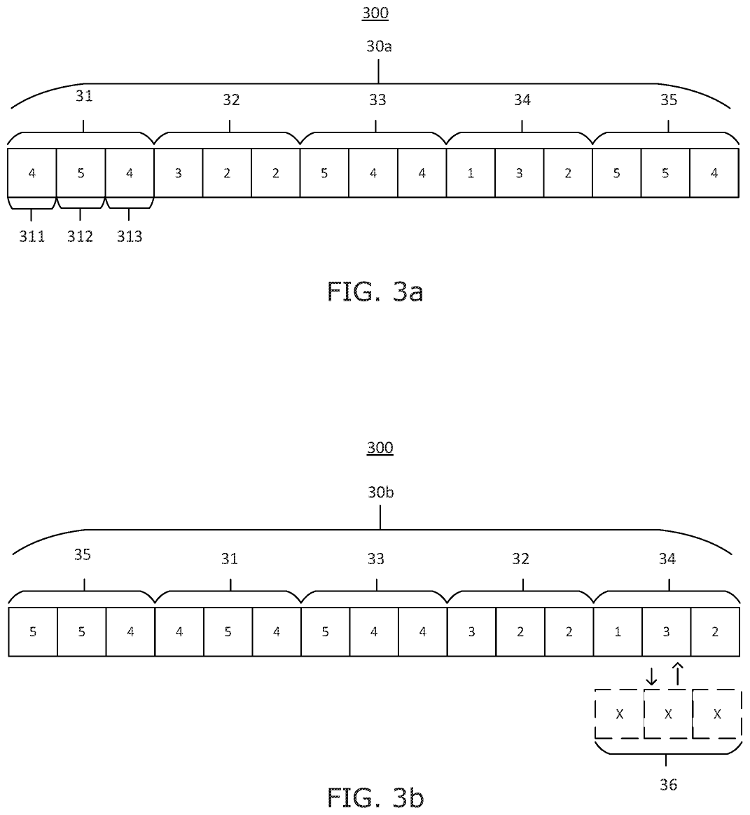

Referring now to FIGS. 3a and 3b, a plurality of printheads 300 comprising a plurality of dies are shown. The plurality of printheads 300 are in a first distribution 30a and comprise a first printhead 31, a second printhead 32, a third printhead 33, a fourth printhead 34, and a fifth printhead 35. Each of the dies has assigned a die darkness level, wherein the die darkness level may be assigned from the darkness value readings of the optical sensor.

In the example of FIG. 3a, the first printhead 31 comprises a first die 311 having a die darkness level of 4, a second die 312 having a die darkness level of 5, and a third die 313 having a die darkness level of 4. A processor (not shown in FIGS. 3a and 3b) calculates a variation value for each of the printheads. The variation value for the first printhead 31 is calculated as the difference between the die darkness levels of the first die 311, the second die 312 and the third die 313. Thereby, the variation value for the printhead 31 is 2, since the first die 311 and the second die 312 are different in one darkness level and the second die 312 and the third die are different in one darkness level. For simplicity reasons, the darkness levels explained in FIGS. 1a to 1a have not been represented.

Referring now to FIG. 3b, the plurality of printheads 300 is shown in a second distribution 30b. The second distribution 30b may be calculated through the processor based on the darkness levels for the plurality of printheads 300, as explained previously in the description in reference to FIGS. 1a to 1b. However, in other examples, the darkness level for the printheads may be calculated from the die darkness levels of the dies comprised in the printheads. In an example, the darkness level of the printhead is an average darkness level of the die darkness levels comprised in the printhead.

In the example represented in FIG. 3b, the fourth printhead 34 has assigned the die darkness levels 1, 3 and 2 for each of the first die, the second die, and the third die. The variation value for the fourth printhead 34 is 3 and the average darkness level of the printhead is 2. A threshold variation value may be defined for the plurality of printheads 300, wherein if a printhead has a variation value greater than the threshold variation value the printhead is to be excluded from the calculation. In the example of FIG. 3b the threshold variation value is 2 and the variation value for the fourth printhead 34 is 3, and thereby, the fourth printhead 34 is excluded from the printhead distribution 30b. In order to fulfill the empty position in the plurality of printheads 300, a sixth printhead 36 is inserted as a replacement. The sixth printhead 36 does not have assigned either die darkness levels or darkness level for the printhead, but in other cases the dies darkness levels and the darkness level of the printhead may be known before replacing a printhead in the printhead distribution. In an example, upon the printhead replacement a second calibration pattern is printed through the plurality of printheads and the calibration pattern may be a first calibration pattern. The processor may determine a new printhead distribution from the second calibration pattern, The new printhead distribution may be calculated as previously explained in the description.

However, in other examples, the printhead may need to fulfill a list of specifications to remain in the calculation of a printhead distribution. The list of specifications may comprise at least one from the set of a minimum average darkness level within the printhead, a maximum average darkness level within the printhead, and a maximum variation across the dies within the printhead. In case the printhead does not fulfill one of the conditions, the printhead is to be excluded from the calculation.

The examples described in FIGS. 1a to 3b may be performed by a processor of a calibration device. The calibration device may comprise an optical sensor and the processor to determine a printhead distribution.

According to an example, a printing system comprises a plurality of printheads, a processor, and an optical sensor. The printing system may read a calibration pattern comprised in a media. The plurality of printheads comprise a series of nozzles, wherein the printheads to print the calibration pattern on the media. The processor may calculate a printhead distribution for the plurality of printheads. The optical sensor may capture darkness values for the series of nozzles and may send a signal to the processor. The processor may assign a darkness level to each printhead based on the signal, and the printhead distribution may be calculated so that a variation of the darkness level across the plurality of printheads is minimized.

In some examples, the processor of the printing system may execute the calculations described in FIGS. 1a to 2b.

In other examples, the series of nozzles are comprised in dies and the dies are comprised in the printheads. The printing system may calculate the printhead distribution for the plurality of printheads through the processor. The processor may calculate the printhead distribution as described in FIGS. 3a to 3b.

In an example, the plurality of printheads of the printing system are grouped in a series of printheads subsets, The processor of the printing system may calculate a plurality of printheads distributions that minimize the variation of the darkness level within each subset of printheads. However, different criteria may be applied for the calculation, as described from FIG. 1a to FIG. 3b.

According to some examples, a calibration method to calculate a printhead distribution may comprise printing a calibration pattern through a series of nozzles, detecting darkness values from the calibration pattern through an optical sensor, assigning a darkness level to each printhead based on the darkness values, and calculating the printhead distribution through a processor. The calibration method may be executed by a calibration device, and hence, the examples described in reference to FIGS. 1a to 3c may apply to the plurality of printheads, the processor, and the optical sensor.

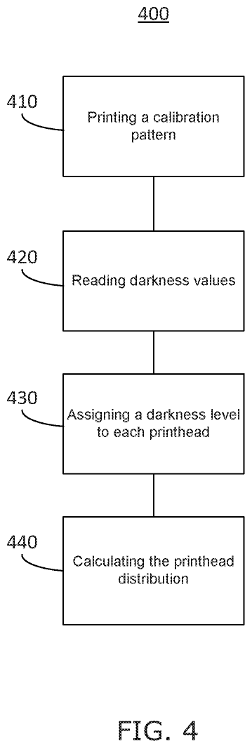

Referring now to FIG. 4, a calibration method 400 to calculate a printhead distribution is shown. The calibration method 400 comprises printing a calibration pattern 410, detecting darkness values 420, assigning a darkness level to each printhead 430, and calculating the printhead distribution 440. Printing the calibration pattern 410 may be performed through a series of nozzles, wherein the series of nozzles are comprised within a plurality of printheads. The plurality of printheads may flush a target amount of printing fluid through the series of nozzles to print the calibration pattern. The darkness values are detected from the calibration pattern through an optical sensor. The darkness levels assigned to each of the printheads are based on the darkness values detections. Calculating the printhead distribution 440 comprises calculating the distribution that minimizes a variation of the darkness level across the plurality of printheads. In other examples, the printhead distribution criteria may be different, such as minimizing a number of printhead changes or a distance between the printhead changes.

In an example, the calibration method may further comprise comparing the darkness levels of each printhead with a threshold darkness level and excluding from the calculation the printheads for which the variation value is greater than a threshold variation value. The comparison may be performed so that the printheads having darkness levels which do not exceed the threshold darkness level are excluded from the calculation of the printhead distribution.

As previously explained in FIGS. 3a and 3b, the plurality of printheads may comprise dies and those dies may have assigned a die darkness level. The die darkness level may be assigned based on the darkness value readings for the dies. In an example, the calibration method may further comprise calculating a variation value across each printhead and excluding from the calculation of the printhead distribution the printheads for which the variation value is greater than a threshold value.

According to some examples, the processor may receive printhead data from a server. The printhead data may comprise printing fluid usage data and operating life data for the plurality of printheads. The calibration method may compare the printing fluid usage data or the operating life data of the printheads to be excluded with a minimum printing fluid usage and a minimum life. If the printing fluid usage data or the operating life data of the printheads to be excluded from the printhead distribution calculation are lower than the minimum printing fluid usage and the minimum life, the printheads are not excluded from the calculation.

In other examples, the plurality of printheads may be distributed in a series of parallel printbars and calculating the printheads distribution further comprises calculating a printbar distribution for each printbar. The printbar distribution calculation may minimize a bar-to-bar variation of the darkness levels of the parallel printheads positioned across the printbars, as previously explained in reference to FIGS. 2a and 2b. In some examples, the calculation of the printhead distribution across the series of printbars comprises determining a plurality of printhead changes. In an example, the calculation of the printhead distribution across the series of printbars comprises to determine a plurality of printheads changes while minimizing a number of printhead changes. However, in other example further characteristics such as a distance between the printhead changes may be included in the calculation.

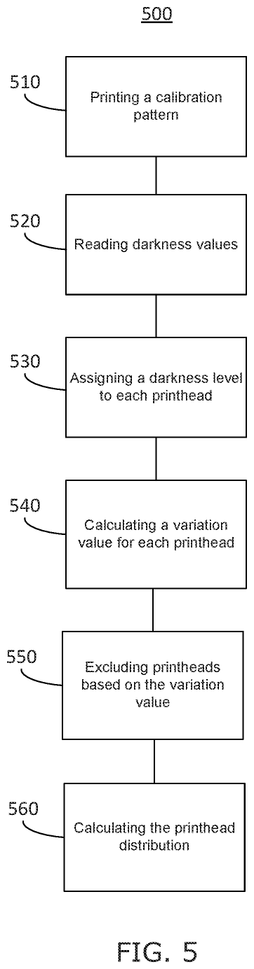

Referring now to FIG. 5, a calibration method 500 to calculate a printhead distribution is shown. The calibration method comprises printing a calibration pattern 510, detecting darkness values 520, assigning a darkness level to each printhead 530, calculating a variation value for each printhead 540, excluding printheads based on the variation value 550, and calculating the printhead distribution 560. The blocks 510, 520 and 530 may be performed as the blocks 410, 420 and 430 of FIG. 4. As explained in FIGS. 3a to 3b, the series of nozzles may be comprised in dies, wherein the dies are comprised in the plurality of printheads. The processor may assign a die darkness level to each of the dies based on the darkness values readings obtained by the optical sensor. Calculating a variation value for each printhead 540 comprises calculating a difference between the die darkness levels of each of the dies comprised within the printhead, and therefore, the variation value is obtained for each printhead. A threshold variation value may be defined for the plurality of printheads so that the processor may compare the variation values of the plurality of printheads with the threshold variation value. Excluding printheads based on the variation value 550 comprises indicating that a printhead has the variation value greater than the threshold variation value. The processor may exclude from the calculation of the printhead distribution the printheads exceeding the threshold variation value. In some examples, the printheads to be excluded may be replaced for new printheads, as explained in reference to FIG. 3b. Calculating the printhead distribution 560 comprises calculating the printhead distribution that minimizes a variation of the darkness level across the plurality of printheads. In some examples, the calculation of the printhead distribution may comprise minimizing the variation of the darkness level while minimizing the number of printhead changes. In other examples, the criteria to calculate the printhead distribution may be weighted.

According to some examples, the calibration method 500 of FIG. 5 may be applied to a plurality of printheads distributed in a series of parallel printbars. As explained in reference to FIGS. 2a to 2b, a series of bar-to-bar variations are calculated for the printheads. Since each printhead may comprise dies, dies darkness levels may be assigned. The calculation of the printhead distribution when having printbars may comprise calculating a printbar distribution for each printbar that minimizes the bar-to-bar variation of he darkness levels of the printheads positioned across the printbars.

In other examples, when having a plurality of printbars, the calculation of the printhead distribution across the series of printbars may comprise to determine a plurality of printhead changes that minimize a number of printhead changes.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

1. A calibration method to calculate a printhead distribution, the method comprising:
Printing a calibration pattern through a series of nozzles, the series of nozzles comprised within a plurality of printheads;
Detecting, through an optical sensor, darkness values from the calibration pattern;
Assigning a darkness level to each printhead based on the darkness values, and;
Calculating, through a processor, the printhead distribution that minimizes a variation of the darkness level across the plurality of printheads.

2. A method as claimed in claim 1, wherein calculating the printhead distribution further comprises comparing the darkness levels of each of the printheads with a threshold darkness level, wherein the printheads having darkness levels which do not exceed the threshold darkness level are excluded from the calculation of the printhead distribution.

3. A method as claimed in claim 1, wherein the series of nozzles are comprised in dies, wherein the darkness values readings are for dies, and wherein a die darkness level is assigned to each of the dies based on the darkness values readings, the method further comprising:
Calculating a variation value across each printhead, wherein the variation value is calculated as a difference between the die darkness levels of each of the dies comprised within the printhead, and;
Excluding from the calculation of the printhead distribution the printheads for which the variation value is greater than a threshold variation value.

4. A method as claimed in claim 2, wherein the processor receives printhead data from a server, the printhead data comprising printing fluid usage data and operating life data for the plurality of printheads, wherein if the printing fluid usage data or the operating life data of the printheads to be excluded are lower than a minimum printing fluid usage and a minimum life, the printheads are not excluded from the calculation.

5. A method as claimed in claim 1 wherein the plurality of printheads are distributed in a series of parallel printbars, wherein calculating the printhead distribution further comprises calculating a printbar distribution for each printbar that minimizes a bar-to-bar variation of the darkness levels of the printheads positioned across the printbars.

6. A method as claimed in claim 5, wherein the calculation of the printhead distribution across the series of printbars comprises to determine a plurality of printheads changes while minimizing a number of printhead changes.

7. A printing system to read a calibration pattern comprised in a media, the printing system comprising:
A plurality of printheads comprising a series of nozzles, the printheads to print the calibration pattern on the media;
A processor to calculate a printhead distribution, and;
An optical sensor to read the calibration pattern from the media, wherein the optical sensor captures darkness values in the calibration pattern and wherein the optical sensor sends a signal to the processor;
Wherein the processor assigns a darkness level to each printhead based on the signal, wherein the processor calculates the printhead distribution that minimizes a variation of the darkness level across the plurality the printheads,

8. A printing system as claimed in claim 7, wherein the plurality of printheads are grouped in a series of printheads subsets, wherein the processor calculates a plurality of printheads distributions that minimize the variation of the darkness level within each subset of printheads.

9. A printing system as claimed in claim 7, wherein if the printhead does not fulfill a list of specifications, the printhead is excluded from the printhead distribution calculation.

10. A printing system as claimed in claim 9, wherein the series of nozzles are distributed in dies, wherein dies darkness levels are assigned to the dies, wherein the list of specifications comprises at least one from the set of a minimum average darkness level within the printhead, a maximum average darkness level within the printhead, and a maximum variation across the dies within the printhead.

11. A printing system as claimed in claim 9, wherein the calibration pattern is a first calibration pattern, wherein the printheads excluded from the calculation are caused to be replaced for new printheads, and wherein upon the replacement a second calibration pattern is printed by the series of nozzles and a second printhead distribution is calculated by the processor.

12. A calibration device to calculate a printhead distribution, the calibration device comprising:
An optical sensor to capture a plurality of marks from a calibration pattern, wherein the optical sensor obtains darkness values from the marks, and;
A processor to determine the printhead distribution, the processor to assign a darkness level to a plurality of printheads based on the darkness values of the marks, wherein the processor calculates the printhead distribution that minimizes a difference of the darkness level across the printheads.

13. A calibration device as claimed in claim 12, wherein the processor excludes from the printhead distribution the printheads having the darkness level lower than a threshold darkness level.

14. A calibration device as claimed in claim 13, wherein the processor receives printhead data comprising printing fluid usage data and operating life data for the plurality of printheads from a server, wherein if the printing fluid usage data or the operating life data of the printheads to be excluded are lower than a minimum printing fluid usage and a minimum operating life, the printheads are not excluded from the calculation.

15. A calibration device as claimed in claim 13, wherein the plurality of printheads are distributed in a series of parallel printbars, wherein the processor further calculates a series of printbar distributions, wherein the series of printbar distributions minimize a bar-to-bar variation of each of the darkness levels of the parallel printheads positioned across the printbars.
